(19) United States
(12) Patent Application Publication
(10) Pub. No.: US 2009/0091950 A1
(43) Pub. Date: Apr. 9, 2009

(54) POWER CONVERTING CIRCUIT WITH OPEN LOAD PROTECTION FUNCTION

(76) Inventors: Hsing-Kuo Chao, Hsin-Chu (TW); Yi-Shan Chu, Hsin-Chu (TW); Yu-Chuan Liu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/867,009

(22) Filed: Oct. 4, 2007

(51) Int. Cl. H02M 3/00

(52) U.S. Cl. 363/15; 363/59; 363/62

(57) ABSTRACT

A power converting circuit with an open load protection function is electrically connected to a power supply providing a first voltage level, and outputs a second voltage level to drive a load. The power converting circuit includes a DC/DC converter and a rectifying element disposed between an output node and an input node of the DC/DC converter that forms a discharging loop with the DC/DC converter. The DC/DC converter receives the power, converts the first voltage level into the second voltage level and outputs the second voltage level to the load. The rectifying element is utilized to release a surge voltage produced by the DC/DC converter in an open load condition.

### BACKGROUND OF THE INVENTION

1. Field of the Invention

The present invention relates to a power converting circuit, and more particularly, to a power converting circuit with an open load protection function.

2. Description of the Prior Art

Due to their small size, high lighting efficiency, long life, high reliability, low power consumption, zero mercury pollution, and resistance to damage, light emitting diodes (LEDs) have been developed and are gradually replacing conventional lighting devices.

Please refer to FIG. 1, which is a diagram of a conventional driving circuit of LEDs. As shown in FIG. 1, a first end of a switch SW is electrically connected to a first end of a diode D, and a second end of the switch SW is electrically connected to a first end of a power source Vi. The second end of the power source Vi is electrically connected to ground. A first end of an input capacitor Ci is electrically connected to the second end of the switch SW, and a second end of the input capacitor Ci is electrically connected to the ground. The first end (i.e., the negative end or N end) of the diode D is electrically connected to the first end of the switch SW, and a second end (i.e., the positive end or P end) of the diode D is electrically connected to the ground. A first end of an inductor L is electrically connected to the first end of the diode D, and a second end of the inductor L is electrically connected to a first end of an output capacitor Co. A second end of the output capacitor Co is electrically connected to the ground. A first end (i.e., the negative end or N end) of the LEDs is electrically connected to the ground, and a second end (i.e., the positive end or P end) of the LEDs is electrically connected to the first end of the output capacitor Co.

The driving method shown in FIG. 1 encounters a number of problems. Firstly, the output capacitor Co is necessary for reducing output voltage ripples of the LED, but the addition of output capacitor Co occupies a large area of the driving circuit and also increases production cost. Secondly, when the power source Vi is not shut down (that is, live line process), changing the LED module will cause the LED module to be damaged, especially when replacing the LED module with another LED module having less LEDs. For example, assume that there are 10 LEDs in the LED module and the forward voltage V_{F} of each LED is 4V, so the resulting output voltage Vo is about 40 V. When the LED module is replaced by a LED module having 2 LEDs, residual voltage of the output capacitor Co will instantaneously cause a large current to flow through the LED module, damaging the LEDs therein. Finally, because of the output capacitor Co, the driving circuit cannot be enabled rapidly, or a large surge current will be generated. Therefore, a soft start controlling design is required.

Please refer to FIG. 2, which shows a diagram of another conventional driving circuit of LEDs. As shown in FIG. 2, a first end of a switch SW is electrically connected to a first end of a diode D, and a second end of the switch SW is electrically connected to a first end of a power source Vi. The second end of the power source Vi is electrically connected to ground. A first end of an input capacitor Ci is electrically connected to the second end of the switch SW, and a second end of the input capacitor Ci is electrically connected to the ground. The first end (i.e., the negative end or N end) of the diode D is electrically connected to the first end of the switch SW, and a second end (i.e., the positive end or P end) of the diode D is electrically connected to the ground. A first end of an inductor L is electrically connected to the first end of the diode D, and a second end of the inductor L is electrically connected to a second end (i.e., the positive end or P end) of LED. A first end (i.e., the negative end or N end) of the LED is electrically connected to the second end (i.e., the positive end or P end) of the diode D. The driving circuit in FIG. 2 reduces the output voltage ripples of the LED by increasing the inductance value of inductor L. The output capacitor Co is therefore not needed, and the overall size and production cost of the driving circuit is decreased. Moreover, the circuit can be enabled quickly because the output capacitor Co has been removed. However, when a breakdown such as an open-circuit condition occurs to the LEDs, the energy stored in the inductor L is unable to be released, which may generate a surge voltage of up to several hundred volts and damage the system. The larger inductance value of the inductor L is, the more serious damage the surge voltage causes.

For example, assume that an average current flowing through the LEDs is 500 mA, the inductor L=220 μH, and the parasitic capacitor of the circuit is 1000 pF. According to the conservation of energy:

$$\frac{1}{2} L \cdot Δ {I}^{2} = \frac{1}{2} C \cdot Δ {V}^{2} ,$$

a surge voltage

$$Δ V = Δ I \cdot \sqrt{\frac{L}{C}} = 0.5 \cdot \sqrt{\frac{220 u}{1000 p}} = 234.52$$

V will be generated when an open fault occurs to the LED, resulting in a dangerous situation. Especially when the inductor L has a large inductance and the current flowing through the LED is large, the surge voltage resulted from the open fault may be huge and cause serious damages.

Please refer to FIG. 3, which is a diagram of another conventional driving circuit of LEDs. As shown in FIG. 3, a first end of a switch SW is electrically connected to a first end of a diode D, and a second end of the switch SW is electrically connected to a first end of a power source Vi. The second end of the power source Vi is electrically connected to the ground. A first end of an input capacitor Ci is electrically connected to the second end of the switch SW, and a second end of the input capacitor Ci is electrically connected to the ground. The first end (i.e., the negative end or N end) of the diode D is electrically connected to the first end of the switch SW, and a second end (i.e., the positive end or P end) of the diode D is electrically connected to the ground. A first end of an inductor L is electrically connected to the first end of the diode D, and a second end of the inductor L is electrically connected to a first end (i.e., the negative end or N end) of a Zener diode Dz. A second end (i.e., the positive end or P end) of the Zener diode Dz is electrically connected to the ground. A first end (i.e., the negative end or N end) of the LEDs is electrically connected to the ground, and a second end (i.e., the positive end or P end) of the LEDs is electrically connected to the first end (i.e., the negative end or N end) of the Zener diode Dz. The driving circuit shown in FIG. 3 additionally increases the Zener diode Dz for open-circuit protection. When the LEDs are in open-circuit situations, energy stored in the inductor L can be released via the Zener diode Dz. Hence, the surge voltage generated by the inductor L is suppressed at the breakdown voltage of the Zener diode Dz, thereby achieving the effect of open-circuit protection.

However, in order to provide the protection, the breakdown voltage of the Zener diode Dz needs to be higher than the forward voltage V_{F} of each LED multiplied by the number of the LEDs. For instance, 15 LEDs are serially connected at the output of the driving circuit and the forward voltage V_{F} of each LED is 4V, so the breakdown voltage of the Zener diode Dz must be higher than 60V. From this requirement, utilizing a Zener diode Dz with a high wattage and a high breakdown voltage for protection in a high-power illumination implementation will result in high production costs. Moreover, the design of the driving circuit is not flexible since the choosing of the Zener diode Dz must correspond to the forward voltage V_{F} of each LED as well as the total number of the LEDs in the implementation.

Please refer to FIG. 4, which is a diagram showing another conventional driving circuit of LEDs. As shown in FIG. 4, a first end of a switch SW is electrically connected to a first end of a diode D, and a second end of the switch SW is electrically connected to a first end of a power source Vi. The second end of the power source Vi is electrically connected to the ground. A first end of an input capacitor Ci is electrically connected to the second end of the switch SW, and a second end of the input capacitor Ci is electrically connected to the ground. The first end (i.e., the negative end or N end) of the diode D is electrically connected to the first end of the switch SW, and a second end (i.e., the positive end or P end) of the diode D is electrically connected to the ground. A first end of an inductor L is electrically connected to the first end of the diode D, and a second end of the inductor L is electrically connected to a first end of a resistor R1. A second end of the resistor R1 is electrically connected to a first end of a resistor R2 and a non-inverting input end of a comparator. A second end of a resistor R2 is electrically connected to the ground. An inverting input end of the comparator receives a reference voltage level V_{ref}, while an output end of the comparator is electrically connected to an input end of a gate driver. An output end of the gate driver is electrically connected to a gate of a transistor switch NMOS, and a source of the transistor switch NMOS is electrically connected to a first end of a resistor R3. A second end of the resistor R3 is electrically connected to the ground. A drain of the transistor switch NMOS is electrically connected to the second end of the inductor L. A first end (i.e., the negative end or N end) of the LEDs is electrically connected to the ground, and a second end (i.e., the positive end or P end) of the LEDs is electrically connected to the second end of the inductor L. In FIG. 4, the output voltage Vo of the driving circuit is detected and divided. Then the divided output voltage is compared to the reference voltage level V_{ref}. The occurrence of an open circuit of the LEDs is determined when the comparing result shows that the divided output voltage is larger than the reference voltage level V_{ref}. In this situation, the gate driver outputs a driving signal to turn on the transistor switch NMOS. Energy stored in the inductor L is therefore released to zero through the transistor switch NMOS and the resistor R3, and damages caused by the surge voltage can be avoided. Because the Zener diode Dz is not required for protection in this circuit, production cost can be reduced. However, this driving circuit still has drawbacks: the detecting and controlling circuits are complex, and there is a delay problem in signal detection and control.

### SUMMARY OF THE INVENTION

One objective of the present invention is therefore to provide a power converting circuit with an open load protection function. In the present invention, a surge voltage generated by a DC/DC converter in an open load situation is released through a discharging loop. Therefore, problems caused by the surge voltage when connecting or disconnecting the load are avoided.

According to an exemplary embodiment of the present invention, a power converting circuit with an open load protection function is disclosed. The power converting circuit is electrically connected to a power source providing a first voltage level, and outputs a second voltage level to drive the load (e.g., lighting elements). The power converting circuit includes a DC/DC converter and a rectifying element disposed between an output node and an input node of the DC/DC converter that forms a discharging loop with the DC/DC converter. The DC/DC converter receives the power, converts the first voltage level into the second voltage level and outputs the second voltage level to the load. The rectifying element is utilized to release a surge voltage produced by the DC/DC converter in an open-load condition.

Furthermore, the power converting circuit disclosed in the present invention receives a DC power source providing a first voltage level, converts the first voltage level into a second voltage level, and outputs the second voltage level to a load. The power converting circuit includes a switch, an input capacitor, a diode, an inductor, and a rectifying element. The switch has a first end and a second end, and is closed or open selectively. The input capacitor has a first end and a second end, where the first end of the input capacitor is electrically connected to the second end of the switch, and the second end of the input capacitor is electrically connected to a ground. The diode has a first end and a second end, where the first end of the diode is electrically connected to the first end of the switch, and the second end of the diode is electrically connected to the ground. The inductor has a first end and a second end, where the first end of the inductor is electrically connected to the first end of the diode, and the inductor stores energy from the DC power source. The rectifying element has a first end and a second end, where the first end of the rectifying element is electrically connected to the first end of the input capacitor, and the second end of the rectifying element is electrically connected to the second end of the inductor. When the load is in an open-circuit situation, the inductor, the input capacitor, the diode, and the rectifying element form a discharging loop for releasing a surge voltage, and therefore the energy of the surge voltage can be restored into the input capacitor. The power converting circuit with an open load protection function directly disposes a rectifying element (for example, a diode) between an input end and an output end of the power converting circuit. Therefore, a surge voltage-releasing route is provided when the load is in an open-circuit situation. Because a Zener diode is not required for protection, the production cost associated with the Zener diode can be saved. Moreover, the circuit structure is simple since the detecting and controlling circuits are also not necessary.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional driving circuit of LEDs.

FIG. 2 is a diagram of another conventional driving circuit of LEDs.

FIG. 3 is a diagram of another conventional driving circuit of LEDs.

FIG. 4 is a diagram of another conventional driving circuit of LEDs.

FIG. 5 is a block diagram of a system according to an exemplary embodiment of the present invention.

FIG. 6 is a diagram of a power converting circuit according to a first embodiment of the present invention.

FIGS. 7A and FIG. 7B show a diagram of a power converting circuit according to a second embodiment of the present invention.

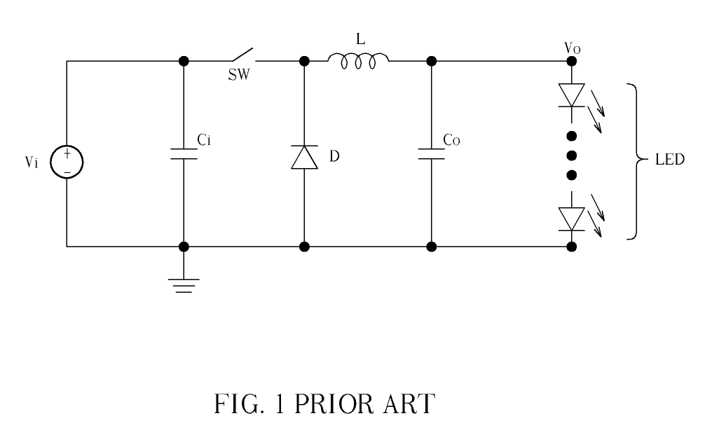

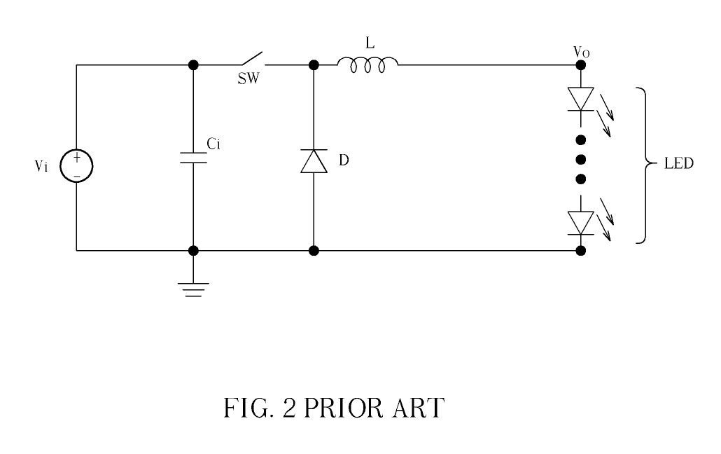

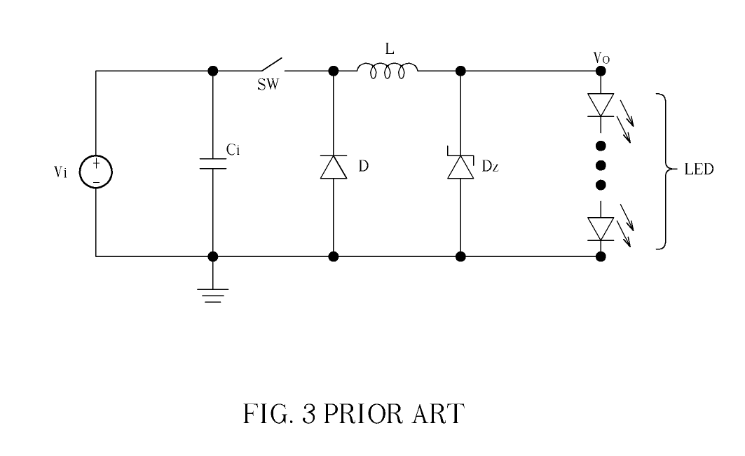

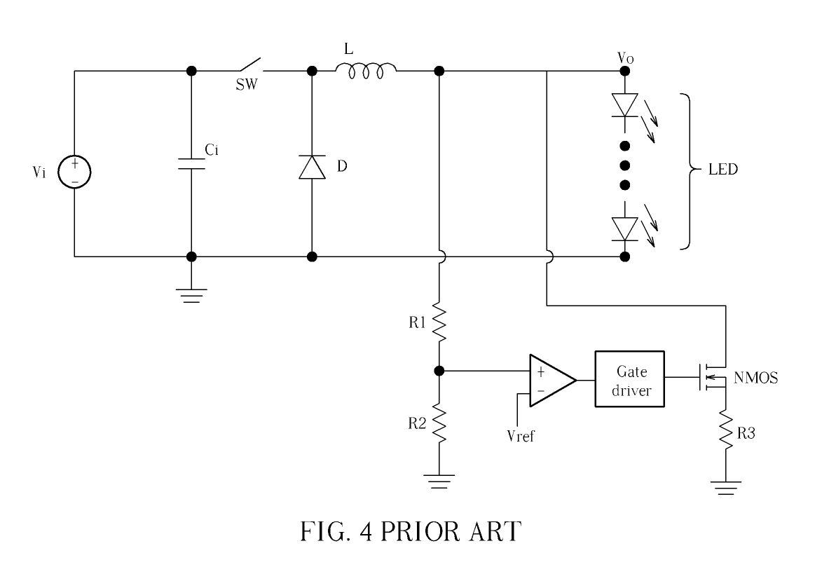

### DETAILED DESCRIPTION

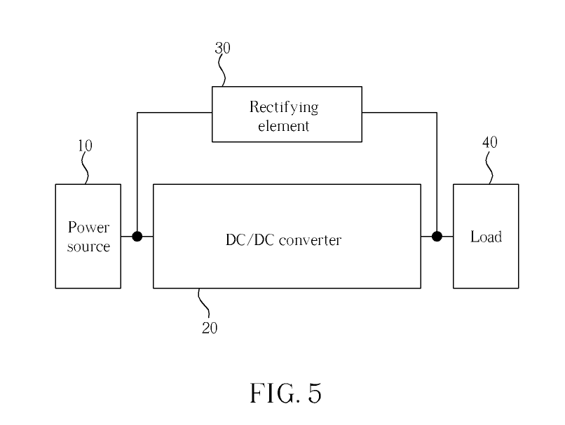

Please refer to FIG. 5, which is a block diagram of a power converting system according to an exemplary embodiment of the present invention. As shown in FIG. 5, a power converting circuit with open load protection function includes a DC/DC converter 20 and a rectifying element 30.

A power source 10 is a DC power source and provides a first voltage level to an input end of the DC/DC converter 20.

The DC/DC converter 20, electrically connected to the power source 10, receives the first voltage level outputted from the power source 10, and converts the first voltage level into a second voltage level. The second voltage level can be higher or lower than the first voltage level. The DC/DC converter 20 can be implemented by a buck DC/DC converter, for example.

The rectifying element 30 is disposed between the input end and an output end of the DC/DC converter 20, forming a discharging loop with the DC/DC converter 20. The discharging loop releases a surge voltage resulting from the DC/DC converter 20 when a load 40 is in an open-circuit situation. The load 40 is electrically connected to the output end of the DC/DC converter 20 to receive the second voltage level outputted by the output end of the DC/DC converter 20. In one embodiment, the load 40 is a lighting element, such as a plurality of LEDs serially connected to each other. The LEDs receive the second voltage level outputted by the DC/DC converter 20, and generate luminance.

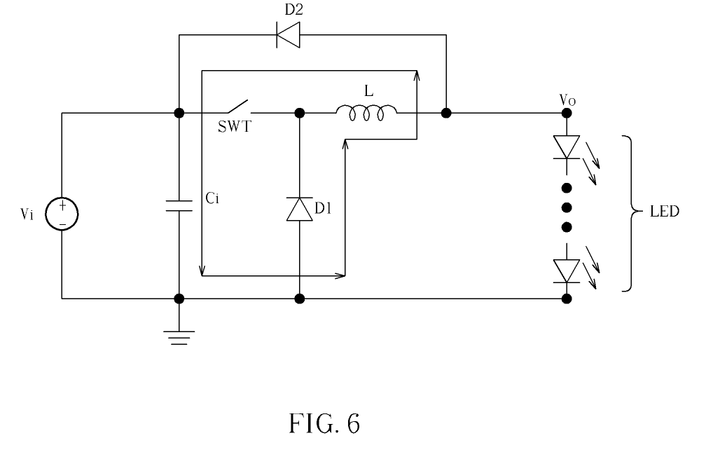

Please refer to FIG. 6, which is a diagram of a power converting circuit according to a first embodiment of the present invention. As shown in FIG. 6, a power converting circuit with open load protection includes a switch SWT, an input capacitor Ci, a first diode D1, an inductor L and a second diode D2.

The switch SWT has a first end and a second end, wherein the first end of the switch SWT is electrically connected to a first end of the first diode D1, and the second end of the switch SWT is electrically connected to a first end of a power source Vi. Note that a second end of the power source Vi is electrically connected to ground.

The input capacitor Ci has a first end and a second end. The first end of the input capacitor Ci is electrically connected to the second end of the switch SWT, and the second end of the input capacitor Ci is electrically connected to the ground.

The first diode D1 has a first end (i.e., the negative end or N end) and a second end (i.e., the positive end or P end). The first end of the first diode D1 is electrically connected to the first end of the switch SWT, and the second end of the first diode D1 is electrically connected to the ground.

The inductor L has a first end and a second end, wherein the first end of the inductor L is electrically connected to the first end of the first diode D1, and the second end of the inductor L is electrically connected to a second end of the second diode D2.

The second diode D2 has a first end (i.e., the negative end or N end) and the second end (i.e., the positive end or P end). The first end of the second diode D2 is electrically connected to the first end of the input capacitor Ci, and the second end of the second diode D2 is electrically connected to the second end of the inductor L. When the LEDs are in open-circuit situations, the inductor L, the second diode D2, the input capacitor Ci and the first diode D1 form a discharging loop to release a surge voltage. Energy of the surge voltage therefore is restored into the input capacitor Ci. The operation principle is described as follows.

When the switch SWT is closed, the power source Vi provides the second voltage level to the LEDs through the inductor L; in the meantime, energy is stored in the inductor L. When the switch SWT is open, the inductor L releases the energy to the LEDs.

As the inductor L is substantially equivalent to a current source, it continues providing current even when an open circuit situation of the LEDs occurs. Note that energy outputted from the inductor L is stored into the output capacitor Co in the prior art. In this embodiment, however, the second diode D2 provides a route for releasing energy, and energy outputted from the inductor L is restored in the input capacitor Ci through the second diode D2. In this way, current provided by the inductor L is gradually decreased to zero, avoiding the instantaneous generation of a high surge voltage. Moreover, energy restored in the input capacitor Ci can be recycled to be reused.

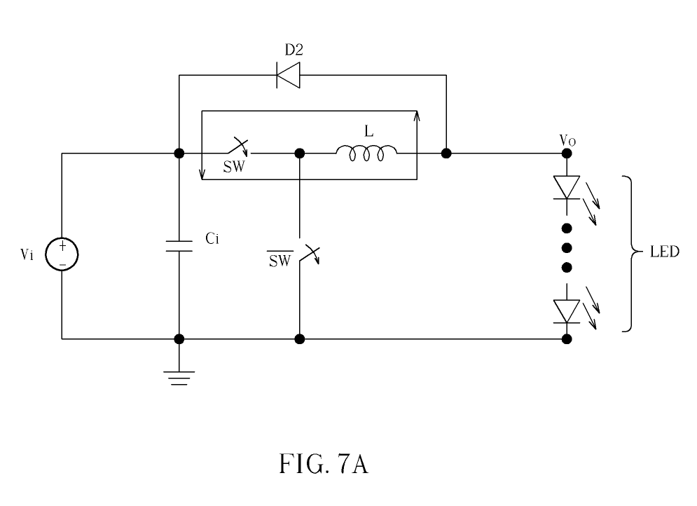

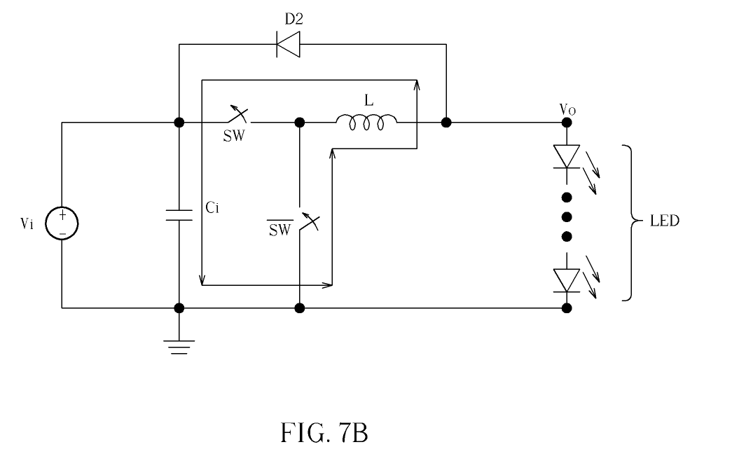

Furthermore, the DC/DC converter shown in FIG. 6 is but not limited to an asynchronous rectifying buck converter. The DC/DC converter can be implemented by a synchronous rectifying buck converter, as shown in FIG. 7A and FIG. 7B. The load 40 is not limited to be implemented as a lighting element (e.g. LEDs); other elements such as memory, processor, controller or stepping motor can be used in the load 40 as well.

Please refer to FIG. 7A in conjunction with FIG. 7B. FIG. 7A and FIG. 7B show a diagram of a power converting circuit according to a second embodiment of the present invention. As shown in FIG. 7A and FIG. 7B, a power converting circuit with open load protection includes a first switch SW, an input capacitor Ci, a second switch S̅w̅, an inductor L and a second diode D2.

The first switch SW has a first end and a second end, wherein the first end of the switch SW is electrically connected to a first end of the second switch S̅w̅, and the second end of the first switch SW is electrically connected to a first end of a power source Vi. A second end of the power source Vi is electrically connected to the ground.

The input capacitor Ci has a first end and a second end. The first end of the input capacitor Ci is electrically connected to the second end of the first switch SW, and the second end of the input capacitor Ci is electrically connected to the ground.

The second switch S̅w̅ has a first end and a second end, wherein the first end of the second switch S̅w̅ is electrically connected to the first end of the first switch SW, and the second end of the second switch S̅w̅ is electrically connected to the ground. Note that operation of the second switch S̅w̅ is opposite to that of the first switch SW. That is, when the second switch S̅w̅ is closed, the first switch is open; when the second switch S̅w̅ is open, the first switch is closed.

The inductor L has a first end and a second end, wherein the first end of the inductor L is electrically connected to the first end of the second switch S̅w̅, the second end of the inductor L is electrically connected to a second end of the second diode D2.

The second diode D2 has a first end (i.e., the negative end or N end) and the second end (i.e., the positive end or P end). The first end of the second diode D2 is electrically connected to the first end of the input capacitor Ci, and the second end of the second diode D2 is electrically connected to the second end of the inductor L. The following explains the operation principle of the discharging loop in an open-circuit situation.

As shown in FIG. 7A, when the first switch is closed, the second switch S̅w̅ is open, the power source Vi provides the second voltage level to the LEDs through the inductor L; meanwhile, energy is stored in the inductor L. When the LEDs are in open-circuit situations, the inductor L continues providing current even though there is no output capacitor Co to store the energy provided by the inductor L. At this time, the second diode D2, the first switch SW and the inductor L form a discharging loop.

As shown in FIG. 7B, when the first switch SW is open, the second switch S̅w̅ is closed, the inductor L releases the energy to the LEDs. As the inductor L is substantially equivalent to a current source, it continues providing current when the LEDs are in open-circuit situations. In this situation, the inductor L, the second diode D2, the input capacitor Ci and second switch S̅w̅ form a discharging loop for releasing a surge voltage, and energy outputted from the inductor L is restored in the input capacitor Ci through the second diode D2. In this way, current provided by the inductor L is gradually decreased to zero, avoiding an instantaneous high surge voltage. Moreover, energy restored in the input capacitor Ci can be recycled.

The switch SWT in FIG. 6 can be an electronic switch; for example, a transistor. The first switch SW and the second switch S̅w̅ in FIG. 7A and FIG. 7B can be electronic switchs such as transistors.

Briefly summarized, the power converting circuits with open load protection function in the above embodiments directly dispose a rectifying element (e.g. a diode) between the input end and the output end of the DC/DC converter. When the load is in an open-circuit situation, the rectifying element provides a releasing route for the surge voltage. Therefore, the power converting circuits in the above embodiments do not need to utilize a Zener diode for open load protection; the associated production cost is thereby saved. Moreover, the power converting circuits have simple structures since the detecting and controlling circuits are not required.

Those skilled in the art will readily observe that numerous modifications and alterations of the device and method may be made while retaining the teachings of the invention.

What is claimed is:

1. A power converting circuit with open load protection function, electrically connected to a power source providing a first voltage level and outputting a second voltage level to drive a load, the power converting circuit comprising:
a DC/DC converter, for receiving the power source, converting the first voltage level into the second voltage level, and outputting the second voltage level to the load; and
a rectifying element, disposed between an output node and an input node of the DC/DC converter that forms a discharging loop with the DC/DC converter, wherein the discharging loop is for releasing a surge voltage produced by the DC/DC converter when the load is in an open-circuit situation.

2. The power converting circuit of claim 1, wherein the load is a lighting element.

3. The power converting circuit of claim 2, wherein the lighting element is at least one LED.

4. The power converting circuit of claim 1, wherein the rectifying element is a diode.

5. The power converting circuit of claim 1, wherein the DC/DC converter is a buck DC/DC converter.

6. The power converting circuit of claim 1, wherein the DC/DC converter comprises:
a switch, having a first end a second end;
an input capacitor, having a first end and a second end, wherein the first end of the input capacitor is electrically connected to the second end of the switch, and the second end of the input capacitor is electrically connected to a ground;
a diode, having a first end and a second end, wherein the first end of the diode is electrically connected to the first end of the switch, and the second end of the diode is electrically connected to the ground; and
an inductor, having a first end and a second end, wherein the first end of the inductor is electrically connected to the first end of the diode;
wherein when the load is in an open-circuit situation, the inductor, the rectifying element, the input capacitor, and the diode form the discharging loop.

7. The power converting circuit of claim 6, wherein the switch is a transistor.

8. The power converting circuit of claim 1, wherein the DC/DC converter comprises:
a first switch, having a first end and a second end;
an input capacitor, having a first end and a second end, wherein the first end of the input capacitor is electrically connected to the second end of the first switch, and the second end of the input capacitor is electrically connected to a ground;
a second switch, having a first end and a second end, wherein the first end of the second switch is electrically connected to the first end of the first switch, and the second end of the second switch is electrically connected to the ground; and
an inductor, having a first end and a second end, wherein the first end of the inductor is electrically connected to the first end of the second switch;
wherein when the first switch is closed, the second switch is open, and when the first switch is open, the second switch is closed.

9. The power converting circuit of claim 8, wherein when the load is in an open-circuit situation, the inductor, the rectifying element, the input capacitor, and the second switch form the discharging loop.

10. The power converting circuit of claim 8, wherein when the load is in an open-circuit situation, the inductor, the rectifying element, and the first switch form the discharging loop.

11. The power converting circuit of claim 8, wherein the first switch is a transistor.

12. The power converting circuit of claim 8, wherein the second switch is a transistor.
